(19) United States
(12) Patent Application Publication
(10) Pub. No.: US 2025/0130388 A1
(43) Pub. Date: Apr. 24, 2025

(54) METHOD OF SEPARATING A RIBBON OF OPTICAL FIBERS

(71) Applicant: CommScope Technologies LLC, Hickory, NC (US)

(72) Inventors: Paige E. CANZONIERI, Brooklyn Park, MN (US); Chinmay M. BENDALE, Eden Prairie, MN (US); Jaime GONZALEZ BATISTA, Prior Lake, MN (US); Scott L. CARLSON, Bloomington, MN (US); Laurens Izaäk VAN WUIJCKHUIJSE, Eden Prairie, MN (US)

(73) Assignee: CommScope Technologies LLC, Hickory, NC (US)

(21) Appl. No.: 18/689,755

(22) PCT Filed: Sep. 8, 2022
(86) PCT No.: PCT/US2022/042953

§ 371 Date: Mar. 6, 2024

Related U.S. Application Data
(60) Provisional application No. 63/242,924, filed on Sep. 10, 2021.

(51) Int. Cl. G02B 6/44

(52) U.S. Cl. CPC G02B 6/448

(57) ABSTRACT

A method of separating a ribbon of optical fibers held together by bonding material. The method includes the steps of routing a thread around each of the optical fibers and moving the thread in a first direction to bread the bonding material between the optical fibers.

### CROSS-REFERENCE TO RELATED APPLICATION

This application is being filed on Sep. 8, 2022 as a PCT International Patent Application and claims the benefit of U.S. Patent Application Ser. No. 63/242,924, filed on Sep. 10, 2021, the disclosure of which is incorporated herein by reference in its entirety.

### TECHNICAL FIELD

The present disclosure relates generally to a method of separating a ribbon of optical fibers.

### BACKGROUND

A traditional optical fiber ribbon includes a plurality of optical fibers secured together by a relatively rigid matrix material. The matrix material prevents relative movement between the optical fibers of the fiber ribbon and retains the optical fibers in a row. In particular, the matrix material retains the optical fiber in a linear array such that at any given location along the length of the fiber ribbon the optical fibers are retained in a planar arrangement by the matrix materials. The matrix material protects the optical fibers, allows the optical fibers to be handled as a group and maintains the optical fibers in a predetermined sequence. However, the matrix material also provides the fiber ribbon with a preferred bend orientation and the planar configuration has driven cable designs and fiber management systems having fiber densities that are lower than what is sometimes desired in the marketplace. The optical fibers of a traditional fiber ribbon can be separated from each other (e.g., by stripping off the matrix material) to prepare the optical fibers for splicing or termination.

In recent years, so called “rollable” optical fiber ribbon has increased in commercial acceptance and popularity. In a rollable optical fiber ribbon, the optical fibers are interconnected by bonding material such that the optical fibers are maintained in a predetermined sequence and can be handled together as a group. However, in contrast to a traditional optical fiber ribbon, the optical fibers of a rollable fiber ribbon can be moved relative to one another to a rolled, bunched, or other type of non-planar configuration. The mechanical attributes of rollable optical fiber ribbon have opened the possibility for cable configurations and fiber management systems having higher fiber densities than was possible with traditional optical fiber ribbon. Rollable optical fiber ribbons have been developed with different designs. For example, rollable optical fiber ribbon designs can include intermittent connection points between the optical fibers (e.g., staggered or non-staggered connection points), a sheet of flexible matrix material connecting the optical fibers, a continuous layer of slitted matrix material connecting the optical fibers, beads of matrix material connecting the optical fibers, or other ribbon designs. In some examples, the rollable optical fiber ribbon designs can include groups of two or more optical fibers with a continuous connection and the groups can have intermittent connection points between each of the groups. Example documents disclosing example rollable optical fiber ribbons include: U.S. Pat. Nos. 5,682,454; 10,185,105; 9,880,368; 10,488,609; 10,488,609; 10,007,078; 9,995,896; 9,086,555; and U.S. Patent Application Publication No. 2020/0271879.

### SUMMARY

In one aspect, the present disclosure relates to a method of separating a ribbon of optical fibers. More specifically the present disclosure relates to a method of separating a rollable ribbon of optical fibers. The ribbon includes a plurality of optical fibers, the optical fibers extend between a first and a second end along a fiber axis. The ribbon additionally includes a bonding material between the optical fibers. The method includes the steps of routing at least one thread about each of the optical fibers and moving the thread in a first direction along the fiber axis to break the bonding material between the optical fibers.

In some examples, the method additionally includes the step of routing the thread at the first end of the optical fibers and moving the fibers in a second direction after moving the optical fibers in the first direction to remove the thread from the optical fibers.

In some examples, the bonding material is intermittently spaced between the optical fibers. In some examples, the optical fibers are in groups of two with continuous bonding material between optical fibers in the groups and have intermittent bonding material between each of the groups.

In some examples, the thread is routed by a stitching device. In some examples, the stitching device loops the thread about each of the optical fibers creating stitches.

In some examples, the optical fibers are spaced at a first pitch. In some examples, the method additionally includes the step of changing the first pitch to a second pitch.

In another aspect, the disclosure is related to a method of changing a first pitch of a ribbon of optical fibers. The ribbon extends between a first and a second end along an axis. The fiber optic ribbon includes a plurality optical fibers with bonding material between each of the optical fibers. The method includes the steps of stitching at least one thread of a thickness between each of the optical fibers. The thickness of the thread is a predetermined thickness which is equal to an amount which the first pitch is desired to be expanded, the stitching results in a second pitch.

A variety of additional aspects will be set forth in the description that follows. The aspects can relate to individual features and to combinations of features. It is to be understood that both the forgoing general description and the following detailed description are exemplary and explanatory only and are not restrictive of the broad inventive concepts upon which the examples disclosed herein are based.

### BRIEF DESCRIPTION OF THE DRAWINGS

The accompanying drawings, which are incorporated herein and constitute a part of the description, illustrate several aspects of the present disclosure. A brief description of the drawings is as follows:

FIG. 1 is a ribbon of optical fibers in accordance with the principles of the present disclosure;

FIGS. 2 and 3 are a stitching device creating stitches between the optical fibers of the ribbon of FIG. 1;

FIG. 4 is the ribbon of optical fibers of FIG. 1 with threads stitched between the optical fibers;

FIG. 5 is the ribbon of FIG. 4 with the threads moved in a first direction;

FIG. 6 is the ribbon FIG. 5 with the threads moved in an opposite second direction;

FIG. 7 is the ribbon of FIG. 6 with the threads removed depicting a pitch between the optical fibers;

FIG. 8 is a ferrule;

FIG. 8A is a cross-section of the ferrule of FIG. 8;

FIG. 9 is the ribbon of FIG. 7 with the pitch converted to a different pitch;

FIG. 10 is the ribbon of FIG. 9 with a binder; and

FIG. 11 is the ribbon of FIG. 9 inserted into the ferrule of FIG. 8.

### DETAILED DESCRIPTION

The present disclosure relates generally to separating optical fibers in a ribbon of optical fibers using a thread or threads routed between the optical fibers. The ribbon can be a rollable ribbon having rollable bonding between the optical fibers or a more traditional ribbon having continuous matrix material encapsulating the optical fibers. In one example, the ribbon is a composite ribbon having rollable ribbon type bonding between some of the optical fibers and continuous non-rollable type bonding between others of the optical fibers. The present disclosure also relates to using a thread or threads routed between fibers of a fiber ribbon to establish a new pitch between the optical fibers of the ribbon.

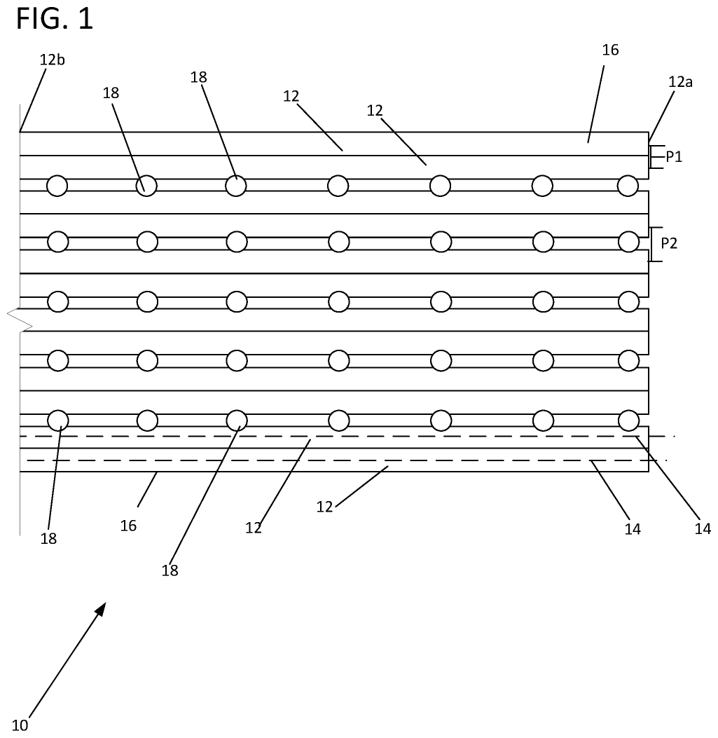

FIG. 1 shows a rollable ribbon 10 including a plurality of optical fibers 12. The optical fibers 12 extend along a fiber axis 14 between a first and a second end 12a, 12b. The optical fibers 12 are in groups 16. In the depicted example, there are two optical fibers 12 in each of the groups 16. The optical fibers 12 include bonding material continuously between one another in the groups 16. The groups 16 are connected to one another at connection points 18. The connection points 18 are spaced intermittently along the fiber axis 14. The connection points 18 can be a bonding material such as a UV curable epoxy. Other bonding materials for both the connection points 18 and the bonding materials between the optical fibers 12 in the groups 16 are possible (e.g., acrylate, other matrix type adhesives etc.). In one aspect, the present disclosure relates to breaking the bonding material of both the connection points 18 and between the optical fibers 12 in groups 16. In one example, the connection points are broken to facilitate establishing to establish a uniform pitch between the optical fibers. In one example, the connection points are broken to reduce stress on the fibers when the fibers are installed in a multi-fiber ferrule having fiber openings arranged at a uniform pitch. By breaking the bonds near the end of the fiber ribbon, a longer pitch transition can be provided between the ribbonized fibers and openings of the multi-fiber ferrule.

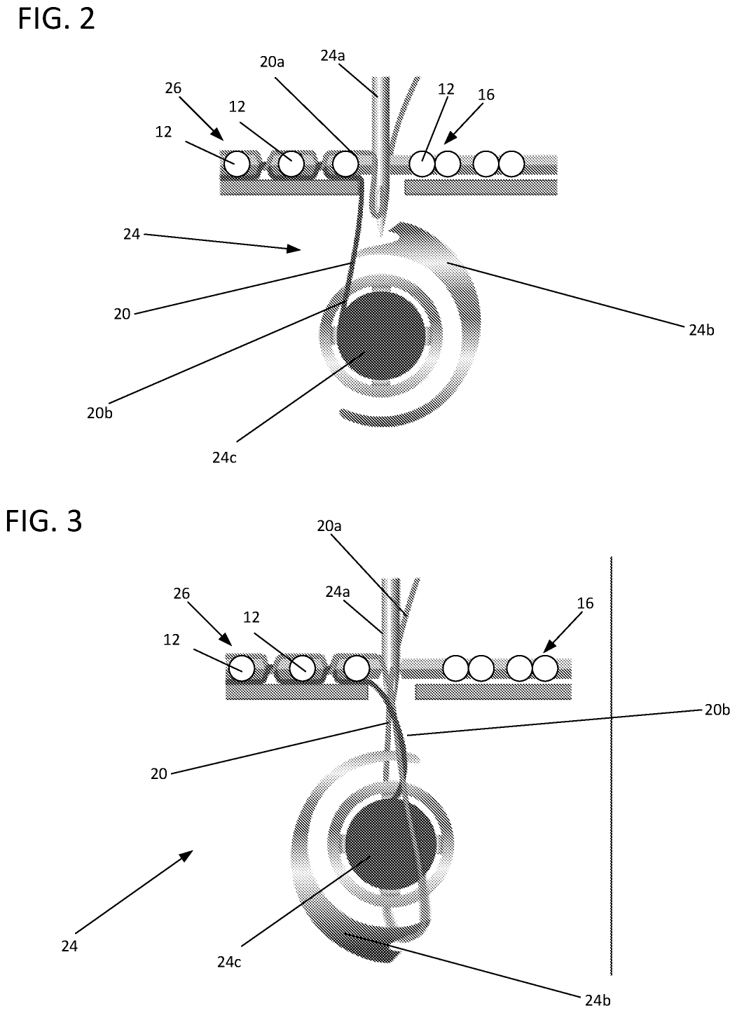

FIGS. 2 and 3 show a thread 20 being routed between each of the optical fibers 12. In this particular example, the thread 20 is routed by a stitching device 24. The stitching device 24 includes a needle 24a and a shuttle hook 24b. The shuttle hook 24b is attached to a bobbin 24c. The needle 24a is attached to an upper thread 20a and the bobbin 24c includes a lower thread 20b. The stitching device 24 moves the needle 24a towards the shuttle hook 24b which catches the upper thread 20a and pulls the upper thread 20a about the bobbin 24c creating a loop about the lower thread 20b (see FIG. 3) this creates a stich 26 (e.g., a loop of the thread 20). The needle 24a moves in a reciprocating motion which can create a row of stiches 26. In the present disclosure, the stiches 26 weave between each of the optical fibers 12. The needle 24a breaks the bonding material and connection points 18 at the location of the stitches 26. The thread 20 can be made from any material that is capable of being stitched and also fits between the optical fibers 12 (e.g., a monofilament material, a stranded material etc.).

The stitching device can be any device capable of creating stiches of one or more threads between each of the optical fibers. In some examples, the stitching device is a sewing machine. In some other examples, the stitching device includes a reciprocating needle similar to the stitching device discussed above. In other examples, other devices that route a thread or threads between optical fibers of a fiber ribbon can be used. The thread or threads are preferably stitched, but non-stitched routing patterns can also be used.

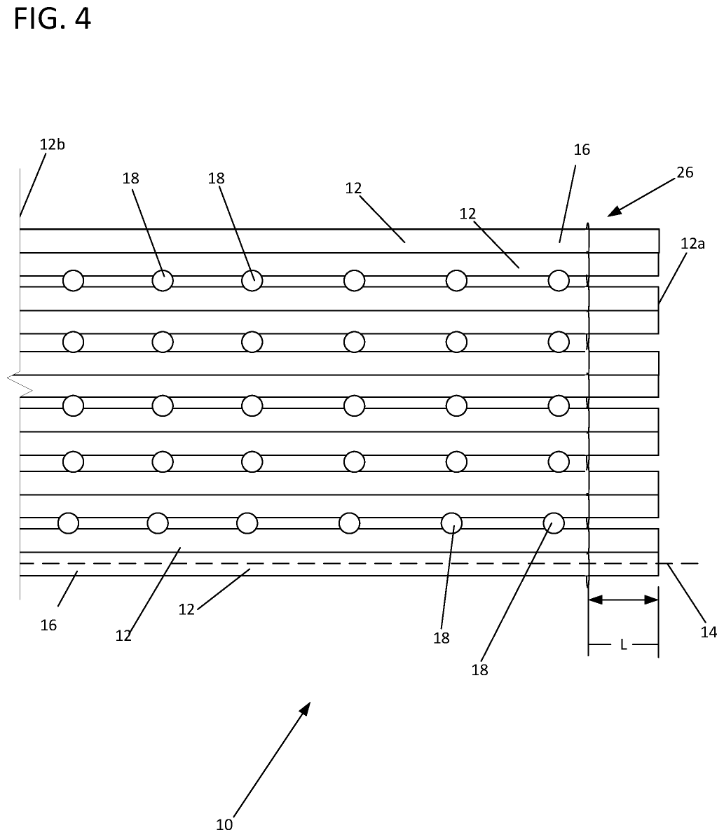

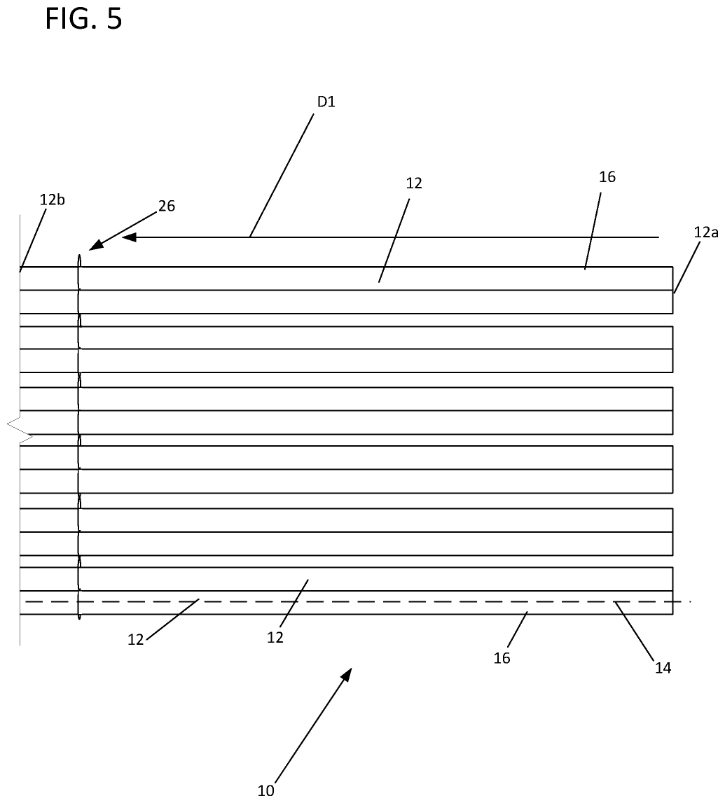

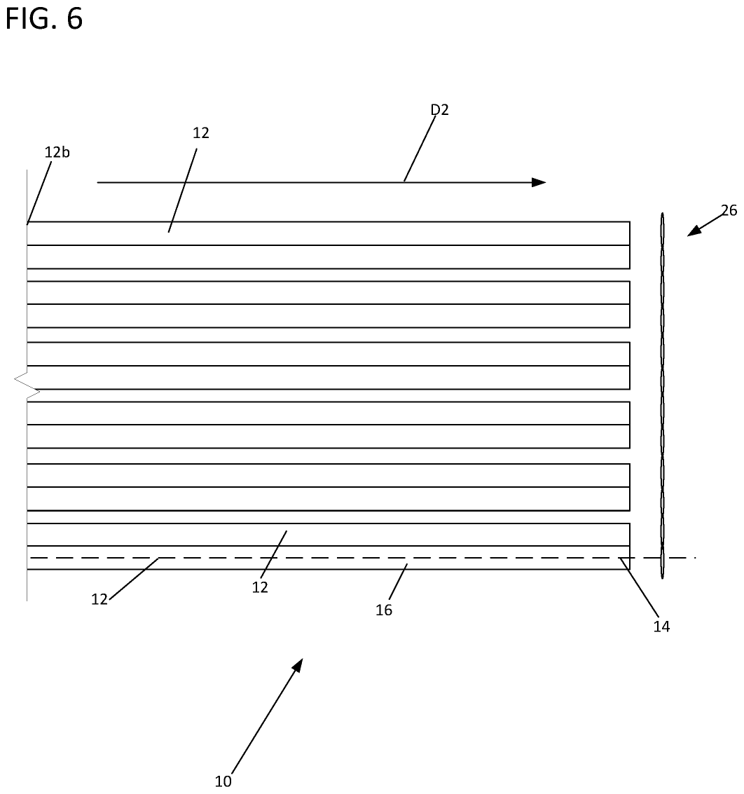

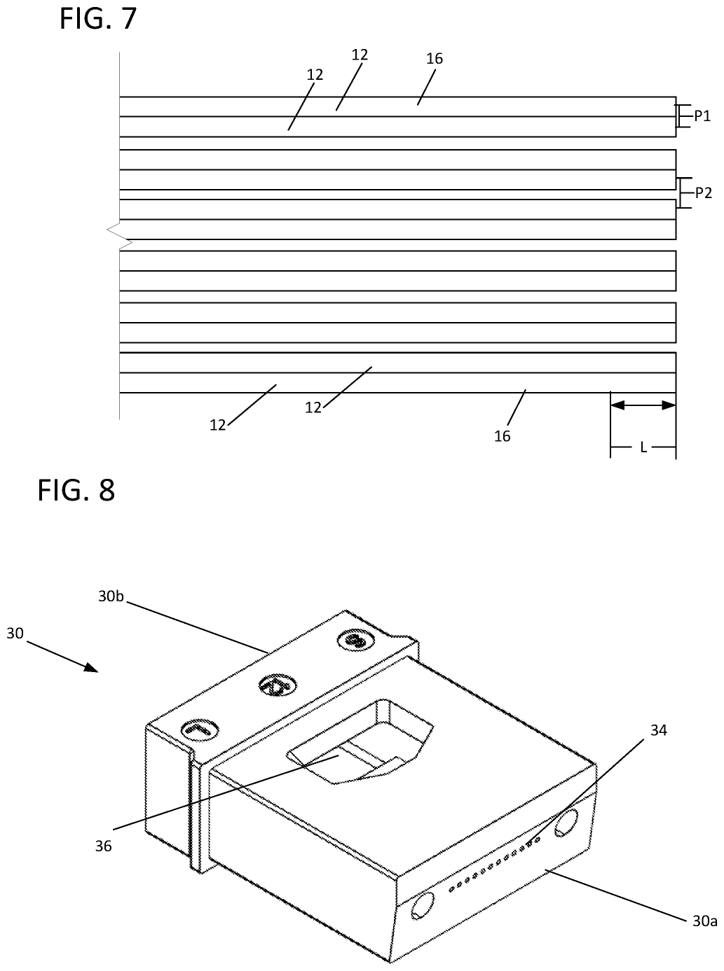

FIG. 4 shows the ribbon 10 with a row of the stitches 26 near the first end 12a of the optical fibers 12. In order to separate the optical fibers 12, the stitches 26 are moved axially in a direction D1 towards the second end 12b (see FIG. 5) which separates the optical fibers 12 from the groups 16 and the connection points 18 by breaking the bonding material between each of the optical fibers 12. In some examples, the stitches 26 are then be moved in a second opposite direction D2 (see FIG. 6) to remove the stitches 26. In other examples, the stitches 26 are be removed in a different manner (e.g., burned off, cut off etc.) or in other examples, the stitches 26 remain on the ribbon 10 depending on the desired application.

In some examples, the stitches 26 are stitches 26 at a length L (see FIG. 4) from the first end 12a. In some examples, the length L is cleaved from the ribbon 10 after the optical fibers 12 are separated to ensure that the optical fibers 12 are not damaged where the stitching device 24 created the stitches 26.

In some examples, the ribbon 10 has a first pitch P1 between the optical fibers 12 in each of the groups 16. In some examples, optical fibers 12 have a second pitch P2 (see FIG. 1) between the optical fibers 12 which are closest to one another in the groups 16 adjacent to one another. In some examples, the first pitch is 200 μm and the second pitch P2 is greater than 200 μm. Having multiple pitches can cause issues when mounting in a ferrule (discussed below), additionally many commercial mass fusion splicers have a fixed pitch of 250 μm and do not work with optical fibers 12 which do not have a pitch of 250 μm.

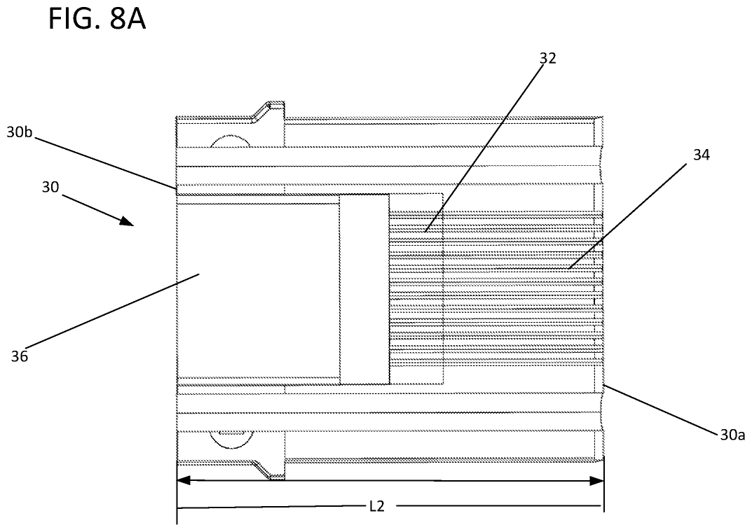

A ferrule 30 and a cross-section of the ferrule 30 are depicted at FIG. 8 and FIG. 8A. The ferrule 30 includes a front end 30a and a rear end 30b. The front end 30a defines openings 34. The ferrule 30 additionally includes internal grooves 32 (which may be u-shaped or v-shaped grooves) located immediately behind openings the 34 for facilitating directing (e.g., guiding etc.) optical fibers 12 through the ferrule 30 and for positioning the fibers at a fixed pitch within the ferrule. The internal grooves 32 extend from where the openings 34 end towards the rear end 30b. The fibers are bonded within the ferrule. The ferrule 30 also defines an epoxy window 36. In one example, the openings 34 and internal grooves 32 have a pitch of 250 μm. It has been found that using a ribbon 10 of optical fibers 12 with multiple pitches, such as the ribbon 10 with pitches P1, P2, often leads to micro-bending in the region behind the v-grooves (e.g., adjacent the epoxy window 36) which can cause Fresnel losses when making optical connections along with other issues. In some examples, the ferrule 30 has a length L2.

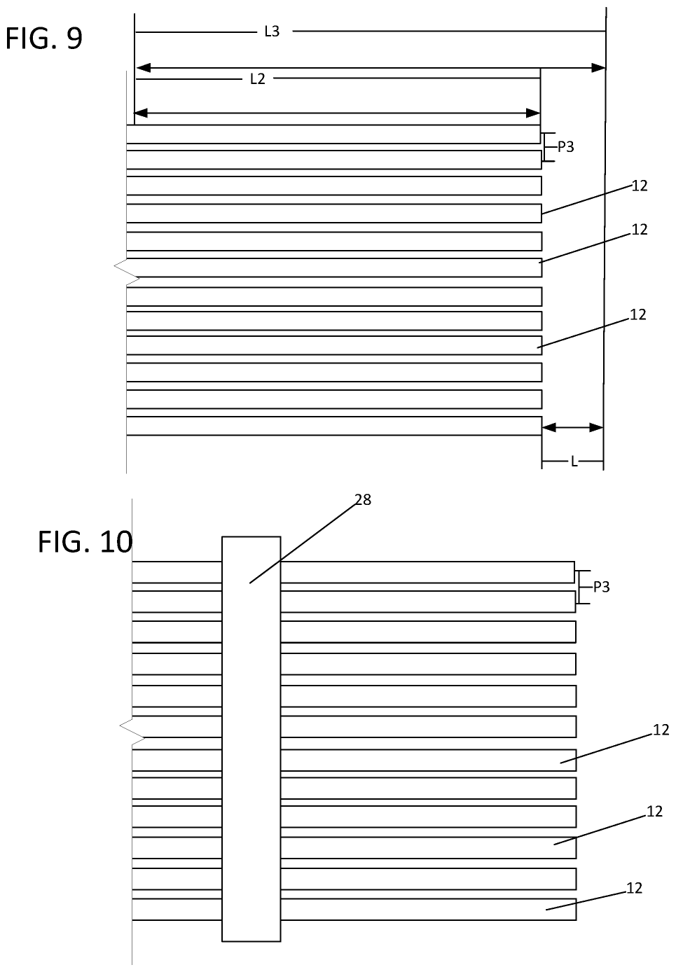

Once the optical fibers 16 are separated by the stitches 26, the pitches P1, P2 can be changed freely. The pitches P1, P2 can be changed such that there is only one pitch. FIG. 9 shows the optical fibers 12 having a pitch P3 between each of the optical fibers 12. In some examples, the pitch P3 is 250 μm. In some examples, the stiches 26 are moved at least a length L3 when breaking the bonding material, the length L3 is the length L and L2 added together such that the ribbon 10 has a uniform pitch P3 for at least the length of the ferrule 30.

In some examples, the optical fibers 16 are held together after the pitches P1, P2 have been converted to the pitch P3 by a binder 28 (see FIG. 10). In some examples, the binder 28 is polymeric, in other examples the binder 28 is a UV curable epoxy and in other examples the fibers can be secured in a ferrule 30 (discussed below). Other binders are additionally possible.

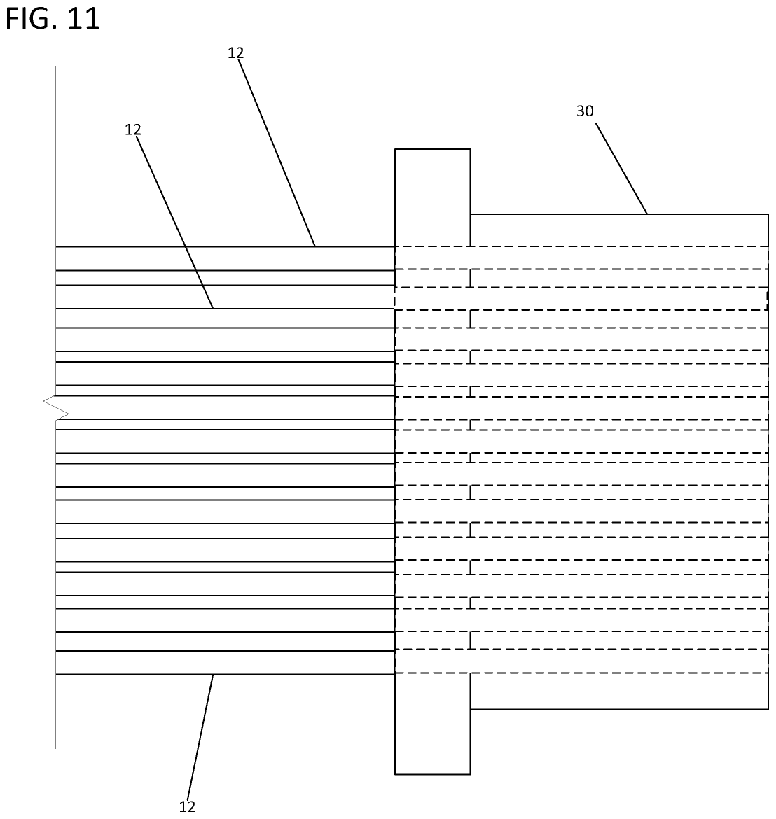

FIG. 11 shows the ribbon 10 with optical fibers 12 having the pitch P3 inserted into the ferrule 30. As there is a uniform pitch which is similar to the pitch of the openings 34 and internal grooves 32 of the ferrule 30, there are no micro-bends or other issues.

In some examples, the thread 20 can have a diameter which is a predetermined distance which the pitch P1 is desired to be changed. In one example, the pitch P1 is 200 μm and the diameter of the thread 20 is 50 μm. When the thread 20 is stitched between each of the optical fibers 12 in the ribbon 10 the pitch P1 is converted to a pitch of 250 μm. Other variations depending on the desired pitch are additionally possible.

From the forgoing detailed description, it will be evident that modifications and variations can be made without departing from the spirit and scope of the disclosure.

The invention claimed is:

1. A method of separating a ribbon of optical fibers, the ribbon comprising a plurality of optical fibers, the optical fibers extending between a first and a second end along a fiber axis, the ribbon including bonding material between the optical fibers, the method comprising:
routing at least one thread about each of the optical fibers; and
moving the thread in a first direction along the fiber axis to break the bonding material between the optical fibers.

2. The method of claim 1, further comprising moving the thread in a second direction after moving the optical fibers in the first direction to remove the thread from the optical fibers.

3. The method of claim 2, further comprising removing a length at the first end of the ribbon wherein the length extends up to a location where the thread was routed from the first end.

4. The method of claim 1, wherein the bonding material is intermittently spaced between the optical fibers.

5. The method of claim 1, wherein the thread is routed by a stitching device.

6. The method of claim 5, wherein the stitching device loops thread about each of the optical fibers creating stitches.

7. The method of claim 1, wherein the optical fibers are in groups of two with continuous bonding material between the groups and intermittent bonding material between each of the groups.

8. The method of claim 7, wherein the optical fibers have a first pitch between the optical fibers in the groups and a second pitch between each of the groups.

9. The method of claim 8, further comprising changing the first pitch and the second pitch to a third uniform pitch between each of the fibers.

10. The method of claim 1, wherein there are at least 2 optical fibers or at least 4 optical fibers or at least 6 optical fibers or at least 8 optical fibers or at least 10 optical fibers or at least 12 optical fibers or at least 14 or at least 16 optical fibers in the ribbon.

11. A method of changing a first pitch of a ribbon of optical fibers, the ribbon extending between a first and a second end along an axis, the optical fibers having bonding material between each optical fiber, the method comprising the steps of:
stitching at least one thread of a thickness between each of the optical fibers, wherein the thickness of the thread is a predetermined thickness which is equal to an amount which the first pitch is desired to be expanded resulting in a second pitch.

12. The method of claim 11, wherein the optical fibers are divided into groups, the groups have continuous bonding material between each of the fibers in the group, and the groups have intermittently spaced bonding material between each of the groups.

13. The method of claim 11, wherein there are two optical fibers in each group.

14. The method of claim 11, further comprising the step of removing the thread.

15. The method of claim 14, wherein the thread is removed by burning the thread.

16. The method of claim 11, wherein the first pitch is 200 μm.

17. The method of claim 16, wherein the thread has a diameter of 50 μm and the second pitch is 250 μm.

18. The method of claim 11, wherein the thread is stitched by a stitching device.

19. The method of claim 11, further comprising the step of adding a binder to hold the fibers together.

20. A method of separating a ribbon of optical fibers, the ribbon comprising a plurality of optical fibers, the ribbon including bonding material between the optical fibers, the method comprising:
routing at least one thread between the optical fibers; and
generating axial movement between the thread and the optical fibers to break the bonding material between the optical fibers.

21. A method of establishing a pitch between optical fibers arranged in a row, the method comprising the method comprising:
routing at least one thread between the optical fibers to establish the pitch between the optical fibers.
